(19) United States
(12) Patent Application Publication
(10) Pub. No.: US 2025/0036298 A1
(43) Pub. Date: Jan. 30, 2025

(54) SYSTEM, METHOD AND APPARATUS FOR IMPROVED LOCAL OBJECT STORAGE

(71) Applicants: Douglas Dumitru, Laguna Hills, CA (US); Samuel J. Anderson, Swarthmore, PA (US)

(72) Inventors: Douglas Dumitru, Laguna Hills, CA (US); Samuel J. Anderson, Swarthmore, PA (US)

(21) Appl. No.: 18/786,967

(22) Filed: Jul. 29, 2024

Related U.S. Application Data
(60) Provisional application No. 63/529,611, filed on Jul. 28, 2023.

(51) Int. Cl. G06F 3/06

(52) U.S. Cl. CPC G06F 3/064; G06F 3/061; G06F 3/0679

(57) ABSTRACT

The instant invention builds upon and greatly extends the concept of a block device to encompass additional features and functionality needed to implement high performance and high value storage subsystems. This “Extended Block Device” (EBD) paradigm eliminates restrictive concepts that the block device imposes and replaces them with more flexible options for the application layer to exploit, providing single IO access to any file.

### RELATED APPLICATIONS

The present application claims benefit of priority from U.S. Provisional Patent Application Ser. No. 63/529,611, filed Jul. 28, 2023, entitled “SYSTEM, METHOD AND APPARATUS FOR IMPROVED LOCAL OBJECT STORAGE,” the disclosure of which is incorporated herein by reference.

### FIELD OF THE INVENTION

The application relates generally to techniques to add flexibility to block storage devices by eliminating restrictive concepts that limit the existing block device paradigms, methods for better allocating logical block addresses by providing variable-sized blocks, as well as methods for improving atomic updates.

### BACKGROUND OF THE INVENTION

Block devices are computer components, such as disk drives and other mass storage devices, such as flash-memory and RAM-based disks. Traditionally, for a block storage device, the application that is using the storage accesses the device uses a “block number”. The device driver then translates this block number into a physical address on the device. This translation process usually involves linearly mapping the block number into the corresponding location on the block storage device.

In looking at object storage performance, however, Applicant postulates and describes herein a file system that achieves “single IO” access to any file, a near theoretical update performance, compatibility with Shingled Magnetic Recording (SMR) and zoned media and having exceptional data integrity.

The file system of the instant invention is inspired, in part, by databases from the 1980s and how their rough structures could be implemented on top of a “Fast Block Device” or FBD, technology of which has a first patent filing by Applicant in 2008, and upon which the significant improvements of the instant invention build.

Applicant's research results demonstrate the effectiveness of an “Extended Block Device” or EBD, and how it can optimize file system, database, and other storage applications.

Most storage subsystems are built on top of block devices, which provide basic functionality for storage solutions, but lack features and functionality necessary for many storage solutions. What is needed is more flexibility in this area, and a new paradigm of operation.

### SUMMARY OF THE PRESENT INVENTION

The instant invention is a new paradigm that extends the concept of the aforementioned block device to encompass additional features and functionality needed to implement high performance and high value storage subsystems. This “Extended Block Device” (EBD) eliminates restrictive concepts imposed on the block devices and replaces them with more flexible capabilities and functions for the application layer to exploit, providing single IO access to any file, a re-envisioning of the entire operational paradigm.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements.

The various FIGURES set forth in the text hereinbelow provide representative views of various aspects and features of an extended block device article, system, technique, apparatus and methodology, employing the principles of the present invention in exemplary configurations, in which:

FIG. 1 of the DRAWINGS generally illustrates a prior art simple traditional block memory storage and access paradigm employing byte blocks of uniform size;

FIG. 2 of the DRAWINGS generally illustrates a first improvement over the simplified prior art technique as shown in FIG. 1, showing respective variable length byte blocks instead of fixed blocks, where the blocks hold different amounts of data (different block byte lengths) for each Logical Block Address;

FIG. 3 of the DRAWINGS generally illustrates another feature of the instant invention, the sparseness of the Logical Block Addresses allocation, where the variable size blocks also shown in FIG. 2 can occupy every Logical Block Address or can leave gaps for future use, as shown;

FIG. 4 of the DRAWINGS illustrates another aspect of the instant invention made possible by the paradigm, where contiguous or dispersed groups of the variable-sized blocks shown in FIGS. 2 and 3 can be updated as a single atomic transaction;

FIG. 5 of the DRAWINGS generally illustrates an exemplary embodiment of the instant invention;

FIG. 6 of the DRAWINGS generally illustrates another exemplary embodiment of the instant invention; and

FIG. 7 of the DRAWINGS generally illustrates a further exemplary embodiment of the instant invention.

### DETAILED DESCRIPTION OF THE PRESENT INVENTION

The following detailed description is presented to enable any person skilled in the art to make and use the invention. For purposes of explanation, specific nomenclature is et forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the spirit and scope of the invention.

The present invention is not intended to be limited to the embodiments shown but is to be accorded the widest possible scope consistent with the principles and features disclosed herein.

As mentioned, the aforementioned prior art Fast Block Device and associated methodology, particularly according to Applicant's prior invention, is a device mapping layer that has a completely different purpose than that of standard block devices. Instead of being a simple linear translation of a logical block number to a physical device address, the Fast Block Device and associated methodology dynamically re-map the data to optimize data access and update patterns. This dynamic re-mapping can be used with a variety of storage devices to achieve massive performance improvements over a linear mapped device, as well as other benefits for certain specialized types of hardware. For instance, when the Fast Block Device concept is applied to flash memory, the speed of random writes made to that device can be increased by almost two orders of magnitude.

These earlier and ongoing efforts in the Fast Block Device area are exemplified and set forth in Applicant's various patents, such as U.S. Pat. Nos. 8,380,944, 8,812,778, 9,092,325, 9,535,830, 10,248,359, 10,817,185, 10,860,255, 11,455,099, 11,687,445 and 12,045,162 (collectively “Applicant's prior art”), the disclosures of which are each incorporated herein by reference.

With reference now to FIG. 1 of the DRAWINGS, there is shown the aforementioned paradigm of the prior art techniques, generally designated by the reference numeral 100, where every block is the same size, generally designated by the reference numeral 110. In this paradigm every logical block address uses storage space, regardless of whether it actually has content or has ever been written to, an inefficiency addressed by the improvements in the instant invention.

The present invention starts with extending the concept of a block device set forth in the above and other disclosures to encompass additional features and functionality needed to implement high performance and high value storage subsystems. As mentioned, the “Extended Block Device” (EBD) technology and methodology set forth herein starts by eliminating restrictive concepts that the block device paradigm imposes and replaces them with more flexible options for the application layer to exploit.

In an effort to exemplify various components involved in the various implementations of the improved methodology of the present invention, the following topics are discussed.

Sparse LBAs. Logical Block Addresses (LBAs) usually have a 1:1 relationship with disk blocks, such as shown in connection with FIG. 1. The EBD, however, starts by allowing for an arbitrary number of these LBAs, which, in turn, allows for easier allocation and deletion of LBAs.

Tracking of LBA allocations. The operation of allocating and freeing an LBA is now handled by the EBD. The application does not need to manage allocation bitmaps or use other LBA “available lists” methods.

Variable sized “Blocks”. LBAs reference a variable sized array of bytes instead of a fixed sized block. The flexibility accorded by this new paradigm is not found in the prior art, as illustrated in FIG. 1, and allows applications to directly map structures of varying sizes to a single LBA, greatly reducing the overhead and complexity of implementing a solution, as.

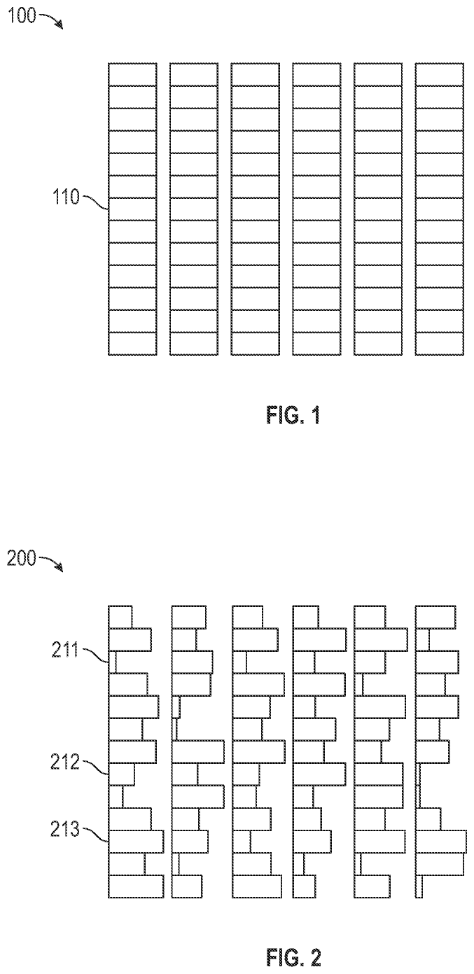

For example and with reference now to FIG. 2 of the DRAWINGS, there is illustrated this improved variable-length block paradigm, generally designated by the reference numeral 200. As shown, the aforementioned blocks have a variety of sizes, from small blocks of perhaps hundreds of bytes, generally designated by the reference numeral 211, to medium-sized blocks of many thousands of bytes, generally designated by the reference numeral 212, to large blocks of perhaps millions of bytes, generally designated by the reference numeral 213. As discussed, the variableness of the block sizes are preferably dependent on the power of two.

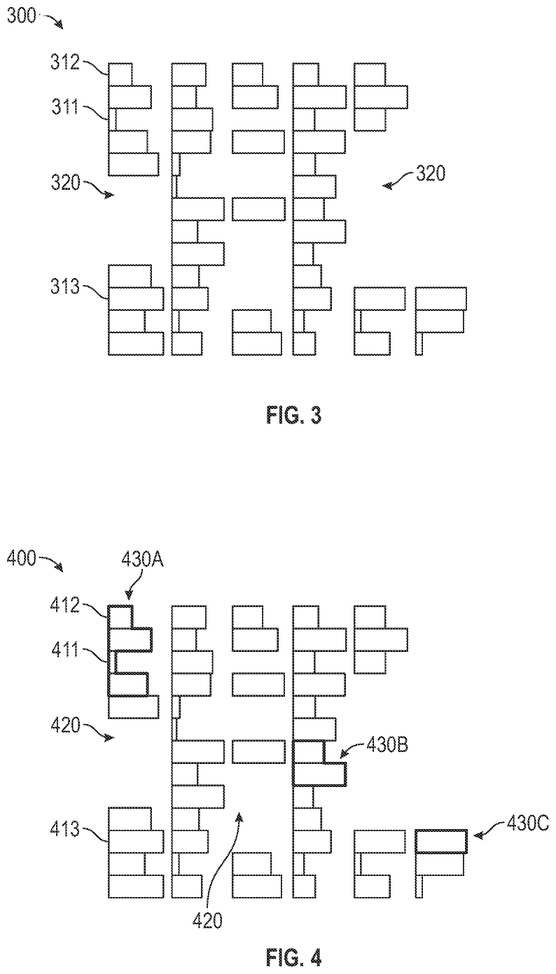

With reference now to FIG. 3 of the DRAWINGS, the sparse allocation process of the instant invention is illustrated, generally designated by the reference numeral 300. In this embodiment, variable size blocks can occupy every Logical Block Address, as illustrated with blocks 311, 312 and 313, or can leave gaps for future use, generally designated by the reference numeral 320. These gaps 320 do not consume storage space. Having a “sparse” allocation strategy makes the design of many applications easier in that they can use contiguous LBA allocation ranges without having to utilize them immediately, or ever.

Atomic Updates. Updates are no longer restricted to the “single block write” model of a block device, as described in detail in Applicant's prior art. Instead, multiple LBA allocations, and multiple LBA updates can now be combined into formal “atomic update” transactions that are thus guaranteed to reach the media intact. These updates can also be appended to and efficiently merge new data and existing in-use data to create an update engine that is efficient and convenient for applications that need to maintain data integrity across a system failure.

With reference to FIG. 4 of the DRAWINGS, there is illustrated the usage of atomic writes within the paradigm of the instant invention, generally designated by the reference numeral 400. Groups of blocks, such as designated by the reference identifiers 430A, 430B and 430C can be updated together as an atomic transaction. As above, gaps 420 are present. Atomic transactions guarantee that either all of the blocks involved are stored on media intact, or none of them are. Atomic updates are one of the hardest parts of building a storage engine, and often involve multiple copies of the same data. This invention implements atomic updates as a part of a single write stream of packed blocks achieving storage efficiency, update consistency, all with a simple and easy to use interface. This simplicity is in sharp contrast to the complexity in handling atomic writes in the prior paradigms.

As noted, the concepts of the instant application are a significant extension over those of the earlier Fast Block Device paradigm, exemplified in Applicant's prior art and as shown in FIG. 1, where the instant case deals with the creation of an “Extended Block Device” (EBD), as well as the creation of an Object Optimized File System utilizing the EBD.

For example, in one embodiment of the instant invention, a block mapping table can optionally be stored in “virtual” memory. The table itself is preferably divided into fixed sized regions, and each region preferably contains a part of the mapping table. The end of each fixed sized region might have pad bytes if evenly divisible by the mapping table element size. The block mapping table virtual memory device is itself an FBD device, optionally residing on the same media as the primary FBD device. The instant technique, employing this improvement, allows FBD to run with much lower dedicated memory requirements.

The number of blocks, and thus the maximum Logical Block Address or LBA in the instant invention can thus be set to an arbitrarily large number. This implements sparse LBAs, where sparse LBAs are known to be useful for application design.

The mapping block in the instant invention is enlarged to allow for more information to be represented in the block beyond the address of stored data, as in the art. This additional information is described in more detail hereinbelow.

The mapping block can now store whether an LBA is available or has been allocated. As mentioned, it should be understood that LBAs can be allocated, but not yet store any information.

The present invention includes an interface created to allow applications to allocate and free LBAs, as described hereinabove, both individually and in binary-sized blocks with an upper size limit of at least about 32,768 contiguous LBAs.

As discussed, each LBA can reference a variable sized byte-array in the embodiments of the present invention described herein, as described hereinabove in connection with FIGS. 2-4. This differs from the standard definition of a “block device,” where all blocks are the same size, as exemplified in FIG. 1. Here, each LBA can reference data ranging from empty to about 16 megabytes in size. It should, of course, be understood that the limits can vary from implementation to implementation, and as technology changes. Since variable sized blocks are stored contiguously on the media, this allows for “single IO” access to any size data structure with efficient space utilization.

Variable sized blocks are ideal for applications that naturally have variable sized structures. This includes “hashed collections” where the hashing logic creates a natural distribution of sizes.

All updates of the mapping table and associated blocks pursuant to embodiments of the present invention are performed as formal atomic updates, such as exemplified in FIG. 4. Although atomic updates are part of the original FBD structure paradigm, it is just exposed to the application layer. Atomic updates pursuant to the instant invention now encompass multiple LBAs and multiple mapping blocks, such as the aforementioned block groupings 430A, 430B and 430C. Atomic updates can be appended to and merged within the available atomic update buffering limits.

All updates are maintained as FBD linear updates using the FBD structure and engine.

Secondary writes are supported in the instant invention. LBAs can refer to secondary writes that are written before the primary atomic update is committed. These updates are preferably stored in the FBD map and are fully managed by the FBD atomic update engine. Secondary updates are written to “secondary zones”, either on another region of the current media or on separate media. Secondary writes are fully a part of the FBD atomic update transaction engine.

A POSIX (Portable Operating System Interface) is a set of standard operating system interfaces based on the Unix operating system, and in another embodiment the instant invention preferably employs a POSIX File System that uses the features of the EBD. The EBD allows a “direct access” file system providing for “single IO” file access using a direct hash algorithm. This type of algorithm is generally difficult to implement, but the EBD feature set of the instant invention allows direct mapping of hash group structures to EBD variable sized blocks. EBD atomic updates allow hash group split/merge processing without consideration of data integrity semantics.

A key/value or KV database is akin to the aforementioned POSIX File System, but with a different application programming interface (API) is also envisioned. Similarly, an object store application akin to the POSIX File System, but with an object get/put API, is also envisioned.

In connection with further embodiments of the present invention, below is another description of the technology employed, along with historical context to exemplify the concepts.

By way of background, most storage is built using “Disk Drives” that present a block device abstraction to the application, as described at length in connection with Applicant's prior art. This block device is a collection of same-sized blocks of data, each addressable using an LBA (Logical Block Address), such as shown in FIG. 1. The blocks themselves might be 512 bytes long, or 4096 bytes long, or some other size, but the operative concept here is that they are all the same size.

This all started with actual disk drives. A physical sector was mapped to an LBA. The sector could be retrieved or updated in any order and without restrictions. Each LBA had a physical location where the bytes were stored.

Over time, the “actual disks” started to stretch the definition. First, the concept of a “bad block table” was created so that media defects could be hidden from the application. A small section of sector would be “re-mapped” to a different, otherwise unused, section of the disk drive by the disk's controller.

Then along came “restricted write media.” This is storage media that can be read randomly but has update rules that prohibit random writes. These are in common usage today with NAND Flash based SSDs (Solid-State Drives), and SMR (Shingled Magnetic Recording) based hard disks. These devices can expose the actual underlying media, and some models of SSDs and HDDs (Hard Disk Drives) do exactly this. For SSDs, these are called “zoned drives”. For SMR HDDs, these are called “Host Managed SMR Drives”. Most of these drives do not expose the media's restrictive nature and instead use a drive level controller to superimpose the apparent ability to write randomly, even though the media cannot. For Flash SSDs, this layer is called an FTL (Flash Translation Layer). This layer maps logical block addresses to Flash media locations. This mapping is not static, and every new update changes the mapping table. The design of an FTL is complicated, especially in the area of dealing with unexpected shutdown events without corrupting data. SMR hard disks often have a layer that is similar to the FTL, but the internal mechanisms are often very different, and the FTL name is not used.

Everything is Still a Block: In all of this prior art, the concept of an LBA pointing to a fixed sized block of bytes remains.

The FTL Can Break This Paradigm: The internal logic of an FTL, at least the software based FTL that is a subject of the instant invention, breaks this paradigm in a new way. While existing applications expect the paradigm of a block device, another set of abstractions can be built that far better suits particular storage situations. As discussed, this new paradigm is called an “Extended Block Device”.

The extended block device, as set forth in the various embodiments hereinabove and herein, is different, in terms of what is presented to the application, in at least four important ways, differentiating this technology from the prior art, including Applicant's prior art.

First, blocks are variable sized, as illustrated in FIG. 2. They are more “blobs” than blocks. For example, if the application writes 174 bytes to an LBA, then a future read will read 174 bytes. There are implementation limits, but they are wide enough to handle many storage structures directly as single blocks without the inefficiencies and complications of either cutting a block into sub-sections or linking multiple blocks together. The current implementation limits are 16 bytes at the lower limit, and about 4 megabytes at the upper limit. The special case of a zero-byte block also exists. As discussed, the principles of the present invention are not limited by the specifics of this implementation.

Second, LBAs are sparse, as shown in FIG. 3. The device has many more LBAs than its capacity. This is convenient for the application because the application can allocate large ranges of LBAs that are contiguous numbers. This in turn allows the application to build extremely large structures without requiring matching large extent tables. In combination with large blocks, the size of an extent table in a file system can be reduced by a factor of about one million to one.

Third, block allocations are both large, defined, and tracked. An application can allocate from one to about 32,768 contiguous LBAs in a single call. The allocation must be a power of two, and the LBA returned will always be on a power of two boundaries.

Fourth, updates are flexible, and atomic, such as shown in FIG. 4. Technically, the extended block device supports Large, Mergeable, Scatter Gather, Non-Contiguous, Allocation Aware, Atomic Updates.

With regard to Large, the updates can comprise many megabytes. The current implementation guarantees that at least four maximum sized LBAs can be stored as a part of a single atomic update.

With regard to Mergeable, the updates can be merged before they are committed. If three LBAs are to be updated in one transaction, and a second transaction includes three LBAs, two of which overlap with the queued update, a new update transaction will be built that includes four LBAs as a combination of the transactions. This allows updates to effectively use device bandwidth while still maintaining the update consistency of a truly atomic update.

With regard to Scatter Gather, the update engine allows the application to present blocks as long lists of memory addresses without requiring contiguous memory setup beforehand, which is required under the earlier paradigms in the prior art.

With regard to Non Contiguous, LBAs can be in any order and do not need to be contiguous groups.

With regard to Allocation Aware, LBA allocations and frees are a part of the atomic update structure.

The importance of the atomic update engine described herein cannot be understated. Much of the logic and overhead of a database or file system is dedicated to data integrity across a crash. This is why journals, copy on write, and other techniques exist. The extended block device of the instant invention directly builds complex structures in-place in a manner that is guaranteed to be consistent on media without any of these steps.

For example, a “new object create” operation pursuant to the instant invention involves: one or more allocations of LBAs, an update of one or more existing control LBAs, and the update of one or more new LBAs.

Because all of these can be inside of a single atomic update, either all of these operations make it to the media, or none of them do. There is no longer a need for a log, or for the application to concern itself with the vagrancies of update sequencing to maintain data integrity, which is a serious problem in the prior art.

With regard to Extended Block Device Implementation, this “device” is implemented in software on top of traditional block devices, and/or raw Flash or SMR media. The underlying devices see the workload associated with an FTL. Data is densely packed, creating excellent storage performance and utilization. For media that has limited write endurance (such as NAND Flash), update wear is minimized.

With regard to File System Prototype, a prototype file system has been built using these techniques. This file system is optimized for fast file creation and retrieval. It is not intended for in-place block updates inside of a file.

This file system in this exemplary prototype is more a key/value database or object store, that presents itself as a file system with directories, etc. The performance profile of this file system is basically “one IO” to retrieve any file, and linear writes to create a file. In all, it is very close to theoretical efficiency limits, even though the file system interface is often considered less than convenient.

Benchmarks comparing this file system so contemplated by the instant invention to key/value (KV) databases show that the file system wins most operations, especially for extremely large data sets (this would be an extremely large directory). Update rates of greater than 250,000 files/second from a single thread into a single directly can be maintained against a single Serial Advanced Technology Attachment (SATA) SSD. The structures support high levels of parallelism creating excellent performance with mixed workloads involving millions of directories and billions of files.

By way of further description of the background and basics of the instant invention, a variable block size data storage solution, below is a further discussion of the extendibility of the instant invention over prior block mapping techniques in connection with another embodiment. As discussed, the block mapping layer is herein significantly and paradigmically extended to support new features impossible to adequately support in the prior art.

As discussed, the present invention includes three primary features: Variable Sized Data “blocks,” tracks block allocations and frees in binary ranges from 1 to 32K, and has large, mergeable, atomic updates, all forming a layer referred to as “VBSFBD” for a Variable Block Size Fast Block Device.

Combined, these three features allow mapping of key/value storage techniques directly to media with the following data structure. This structure can be used to represent a key/value store “bucket” or a directory in a file system. As mentioned hereinabove, this storage structure is inspired by the FILE/ITEM storage structure first seen in a class of databases often referred to as “Pick Databases” (named after it's inventor Richard Pick) dating back to the 1970s. This database was known for “single IO” access to any data record using a hashed lookup technique.

The technique described herein keeps the benefits of this original database design but in a much more flexible environment, allowing for automatic scaling of storage as ITEMs are added and deleted, while still maintaining the “single IO” target for performance. Other aspects of the original database design are also extended to allow for large “blob” storage exceeding 1 exabyte or EB. Particular features in this embodiment are discussed hereinbelow.

Header0: This is a small block that holds counter fields. Because of the nature of the directory structure, this block gets updated every time a KV pair or FILE (herein after referred to as an ITEM) is added, modified, or deleted. Because this block is small, the VBSFDB overhead of a write is small and this block can easily be a part of a VBSFBD atomic update. The preferred fields in this block include: the Number of ITEMs, the Number of Active Groups, the Number of Allocated Groups, Permissions, and Timestamps. It should, of course, be understood that alternate or additional fields are contemplated.

Header1: This is a group extents list. It contains a list of LBNs (Logical Block Numbers) that hold groups of ITEMs. This list is for contiguous allocations starting at a single LBN for a single group and growing to 32K LBNs or more allocated at a time. This allocation scheme guarantees a minimum utilization efficiency, while keeping the length of the extent list low enough that the list itself can be stored in a single VBSFBD “block”. This allocation scheme also guarantees that when this extents list is large, it's updates are less frequent, lowering the overhead on updates even for KV/Directory sets containing trillions of ITEMs.

The preferred fields in this block include: the Number of Extents and an Array of Extent LBNs. Also, each extent is preferably allocated starting with 1, 2, 4, . . . , 32K. This binary approach guarantees a minimum allocate efficiency which keeping lookups and extent table size quick. It should, of course, be understood that alternate or additional fields are contemplated.

Group: This is the core of the KV/DIR structure. It contains a listing of ITEMs linearly packed. The preferred fields in this block include: the Header containing the Number of items in group, and an Array of length of each item. It should be understood that this technique is particularly good for fast group searches.

The DIR layout becomes a collection of VBSFBD “blocks” allocated in binary increments. The directory itself is two blocks (Hdr0 and Hdr1) allocated together. As groups are added, they are allocated in binary growing amounts except for the first two allocations which are single blocks.

ITEM: An individual ITEM has a header packed into a group. The group number is calculated with a hash function. If the item is small, it can be stored “in group.” Larger items have their control information stored “in group” with their content in one or more VBSFBD “blocks” using an extents table. The extents table for an ITEM matches the data layout of Header1. This extents table is stored in-group when it is small, and out of group when it becomes large. This, combined with a large VBSFBD maximum block size permits the storage of very large (>1EB) “blobs” with only a single extent table. This structure is optimized for large item storage and retrieval guaranteeing 4 MB or more linearity for large “blobs” with no possibility of fragmentation.

The preferred fields in this ITEM include: an ITEM Hash/Len (8 bytes), which is used for a quick match during group lookup; and an ITEM key (file name), which is verified if the Hash/Len matches. Because the length already matches, memory instead of string compare operations are used. Memory compare operations are thus much faster. The preferred fields in this ITEM further include: Permissions; and Timestamps.

For Small ITEMS, this can include Content therein. For Moderate ITEMs, these may include a small extent table, and for Large ITEMs, these may include any number of LBAs of an external extent table.

ITEM Lookup: Is done with a hash method. Using hashes for KV looking is a common technique. The limitations of hash lookups are twofold. First, you need to predict the number of hash buckets (here called groups), and second, the hash buckets will vary in size.

The first issue of the number of buckets is mitigated by using a group “split merge” function first seen in databases in the mid-1980s. It is believed that this solution comes from a university thesis paper, but the original author and date are not known (although the paper pre-dates 1985). Pieces of this technique are/were used in commercial database products including Prime Information and Open QM.

The complexity of this prior technique is that it worsens the size distribution of groups and also has a complicated update process that is hard to protect in terms of data integrity. The LVSFBD of the present invention eliminates both of these issues. The group size variability is well within the limits of variable block size. The mergeable atomic updates in LVSFBD makes updates a single atomic operation, including all allocations, control blocks, and multiple groups all for group splits and merges without extra logic so long as the entire update is submitted inside of a single transaction, which becomes trivial with the VBSFBD technique described herein in various embodiments.

With regard to the performance at the device, the VFSFBD layer implements a linear write stream. This allows the atomic update engine to coalesce varying sized blocks each using only their byte count of drive space and bandwidth. The split/merge operations are tuned to happen only every X operations (in tests this was set at 32, but this is tunable), keeping the split/merge overhead to under 5%.

With regard to the Split/Merge Implementation, Group split/merge is an isolated function. For a split, a single group is split into two groups. The groups are locked during the operation. The source group(s) is/are read from media before the lock, and the lock is released as soon as the update is scheduled as an atomic write. This keeps the lock both local and of low duration.

Split and merge operations also lend themselves to pre-fetch IO operations. Tests show that sustained KV create operations in excess of two million per second for a single file are easy to reach. Aggregate operations for multiple files scale well as different files are cross-lock free.

The merge operation is similar except that two groups are pre-read from media before the lock is set.

ITEM Content: An ITEM can have payload that varies from a few bytes to many gigabytes. This design is optimized for “KV style” or “object style” accesses where the entire ITEM is created at one time (or at least in large pieces) and the entire ITEM is retrieved at one time. Item extents are stored in lists of large variable sized blocks, 4 MB at a time. This eliminates any impacts of LBN fragmentation.

The following is an example of using the extended block device in a file system “directory” design.

First, a directory structure is the basic lookup unit of building a file system. Directories contain lists of file descriptors. It is important for directories to remain efficient in terms of space usage and in the amount IOs required to retrieve or update entries. A particularly complicated part of file system design is ensuring that directory updates are done in a manner than survives a system “crash” without leaving corrupted blocks on media.

This design uses a hashed directory. This means that a directory has a number of allocated “groups” each of which stores a collection of file descriptors. An advantage of a group lookup method is that it allows direct access to a named file in a single calculation followed by a single IO. The disadvantage of hashed lookups is that the underlying storage is complicated by the variable sized nature of groups.

A directory starts with two variable sized blocks. One is used to hold counts and other simple data about the directory such as update timestamps and permissions. The second is used to hold a table that is the LBAs for the directory groups.

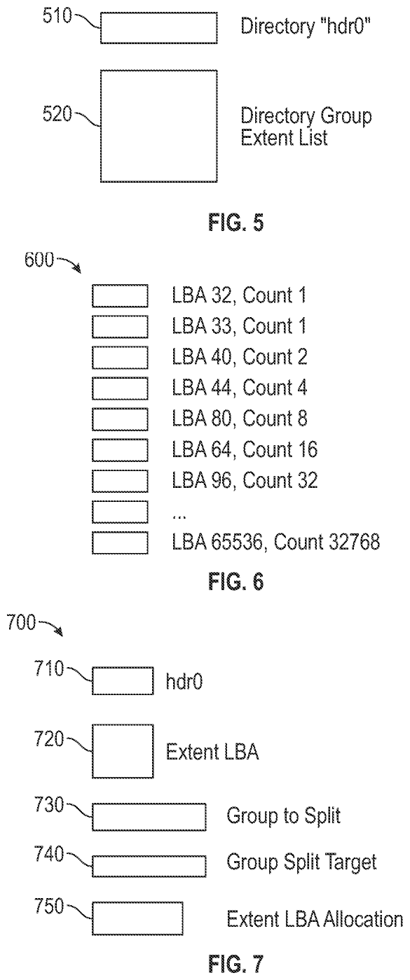

As shown in FIG. 5 of the DRAWINGS, this first block, designated by the reference numeral 510, is quite small. The second block, designated by the reference numeral 520, starts small, but grows as the directory group count grows.

The aforementioned group extent list is a linear array of LBA numbers. Each number represents the beginning LBA of a group. Because of how LBAs are allocated in increasing powers of two, these number represent a growing sequence of LBAs that can be represented in a quite small amount of storage. An example of LBA allocation is shown in FIG. 6 of the DRAWINGS and designated therein by the reference numeral 600.

This power of two allocation progression is remarkably efficient. A single 4 MB block can hold 512,000 entries. These entries can then represent 16,000,000,000 (16 billion) groups which is a file with >250 billion files in a single directory. Even larger directories can be handled by using an extension group extent list. This creates a scenario where a group LBA can be located with very few operations in a quite small memory lookup table.

As the file grows (or shrinks), this table must grow or shrink with it, but for small directories, this block is also small, so the overhead of updates is low. As the directory file count grows, the frequency of updates slows as larger and larger LBAs ranges are involved.

The worst case update is when a file is created that requires a group split, which also requires a new LBA allocation for groups. This operation involves elements illustrated in FIG. 7 of the DRAWINGS, including an hdr0 box, designated by the reference numeral 710, such as shown and described in connection with FIG. 5. Also shown in FIG. 7 are an extent LBA, designated by the reference numeral 720, a group to split, designated by the reference numeral 730, a group split target, designated by the reference numeral 740, and an extent LBA allocation, designated by the reference numeral 750, such as shown and discussed in FIG. 6 hereinabove.

Putting some sizes and numbers to this, if this is a split from 16384 groups to 16385 groups, hdr0 will be small (around 200 bytes). The group extent block has 17 entries, so it is only 136 bytes long. The two groups are variable sized, but likely in the 2K to 4K range. The 16K “LBA allocation” operation does not really involve blocks but needs to be represented inside of the atomic update and represents about 16 bytes. So, the total for this very complicated operation is under 5K of writes to the media, which will be linear because of how the block translation engine works.

With a traditional structure, this would require non-linear writes to a number of blocks and a journal. Recovery from a crash would require structure cleaning. The atomic update nature of the EBD lets a file system “application” perform this update in a single, guaranteed safe, step that ends up create a small single linear IO. Even better, the atomic update engine can coalesce many of these updates into single IO operations enabling file IO update operations that approach the linear speed of the media.

Unless otherwise provided, use of the articles “a” or “an” herein to modify a noun can be understood to include one or more than one of the modified nouns.

While the systems and methods described herein have been shown and described with reference to the illustrated embodiments, those of ordinary skill in the art will recognize or be able to ascertain many equivalents to the embodiments described herein by using no more than routine experimentation. Such equivalents are encompassed by the scope of the present disclosure and the appended claims.

Accordingly, the systems and methods described herein are not to be limited to the embodiments described herein, can include practices other than those described, and are to be interpreted as broadly as allowed under prevailing law.

Finally, the systems and methods described in the various embodiments should not necessarily be limited to just these particular embodiments, but are instead defined by the claims appended hereinunder, by their literal counterparts and, pursuant to equivalents determinations and the doctrine of equivalents, by all equivalent counterparts.

What is claimed is:

1. A method to improve object storage performance, comprising:
linearly writing new data to at least one variable-sized data block,
wherein each of said variable-sized data blocks is tracked by respective Logical Block Addresses,
whereby said method provides single I/O access performance to any object so stored.

2. The method according to claim 1, wherein at least two of said variable-sized data blocks are contiguous.

3. The method according to claim 1, wherein at least two of said variable-sized data blocks are non-contiguous.

4. The method according to claim 1, wherein at least two of said variable-sized data blocks are different sizes.

5. The method according to claim 1, wherein the respective sizes of said variable-sized data blocks allocated are a power of two contiguous bytes.

6. The method according to claim 5, wherein, in said step of linearly writing, allocations of about one to about 32,768 bytes are made.

7. The method according to claim 1, further comprising:
performing an atomic update on said at least one variable-sized data block.

8. The method according to claim 7, wherein said performing an atomic update is performed on a grouping of said variable sized data blocks.

9. The method according to claim 8, wherein said grouping of said variable sized data blocks are contiguous.

10. The method according to claim 8, wherein, within said grouping, at least two of said variable sized data blocks are non-contiguous.

11. The method according to claim 8, wherein a plurality of header fields associated with said grouping contain subfields therein selected from the group consisting of: number of file items, number of active groups, number of allocated groups, permissions, timestamps, number of extents, array listing of Extent Logical Block Addresses, number of items in a group, array listing of item lengths within said group, and combinations thereof.

12. A storage device comprising:
a plurality of variable-sized data blocks, each of said variable-sized data blocks having new data linearly written therein; and
a plurality of Logical Block Addresses, each of said Logical Block Addresses tracking respective variable-sized data blocks sored thereon,
thereby providing single I/O access performance to any object so stored.

13. The storage device according to claim 12, wherein at least two of said variable-sized data blocks are contiguous on said storage device.

14. The method according to claim 12, wherein at least two of said variable-sized data blocks are non-contiguous on said storage device.

15. The method according to claim 12, wherein at least two of said variable-sized data blocks are different sizes.

16. The method according to claim 12, wherein the respective sizes of said variable-sized data blocks sored on said storage device have a size that is a power of two contiguous bytes.

17. The method according to claim 16, wherein the sizes of a respective variable-sized data block is about one to about 32,768 bytes.

18. The method according to claim 12, further comprising:
an atomic update, wherein said atomic update is performed on said at least one variable-sized data block.

19. The method according to claim 18, wherein said atomic update is performed on a grouping of said variable sized data blocks stored on said storage device.

20. The method according to claim 19, wherein said grouping of said variable sized data blocks are contiguous.

21. The method according to claim 19, wherein, within said grouping, at least two of said variable sized data blocks are non-contiguous.

22. The method according to claim 19, wherein a plurality of header fields associated with said grouping contain subfields therein selected from the group consisting of: number of file items, number of active groups, number of allocated groups, permissions, timestamps, number of extents, array listing of Extent Logical Block Addresses, number of items in a group, array listing of item lengths within said group, and combinations thereof.

23. A storage system comprising:
at least one storage device;
a plurality of variable-sized data blocks stored within said at least one storage device, each of said variable-sized data blocks having new data linearly written therein; and
within each said at least one storage device, a plurality of Logical Block Addresses, each of said Logical Block Addresses tracking respective variable-sized data blocks stored thereon,
thereby providing single I/O access performance to any object so stored.
